(19) United States
(12) Patent Application Publication
(10) Pub. No.: US 2004/0205403 A1
(43) Pub. Date: Oct. 14, 2004

(54) Acoustic power spectra sensor for hard disk drive to provide early detection of drive failure and diagnostic capabilities

(76) Inventors: Mitchell Markow, Hutto, TX (US); Jeremy M. Ford, Austin, TX (US); Ricardo V. Dominguez, Georgetown, TX (US)

Correspondence Address: HAMILTON & TERRILE, LLP, P.O. BOX 203518, AUSTIN, TX, 78720, US

(21) Appl. No.: 10/402,024

(22) Filed: Mar. 28, 2003

(51) Int. Cl. H02H 3/05

(52) U.S. Cl. 714/30

(57) ABSTRACT

Hardware component performance in an information handling system is detected with an integrated acoustic power spectra sensor that can be used for diagnostics analysis. The acoustic power spectra data is compared to acoustic models for operative drives to determine an acoustic pass/fail criteria, or to provide more sophisticated analysis of the drive performance, including specific drive failure conditions or impending drive failure conditions.

### BACKGROUND OF THE INVENTION

1. Field of the Invention

The present invention relates in general to the field of detecting information handling system failures. In one aspect, the present invention relates to a method and apparatus for detecting acoustic signals generated by a hard disk drive in an information handling system using an integrated sensor in the hard disk drive.

2. Description of the Related Art

As the value and use of information continues to increase, individuals and businesses seek additional ways to process and store information. One option available to users is information handling systems. An information handling system generally processes, compiles, stores and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated and how quickly and efficiently the information may be processed, stored or communicated. The variations in information handling systems allow for information handling systems to be general or configured for a specific user or specific use such as financial transaction processing, airline reservations, enterprise data storage or global communications. In addition, information handling systems may include a variety of hardware and software components that may be configured to process, store and communicate information and may include one or more computer systems, data storage systems, and networking systems.

The wide variety of uses and flexibility of information handling systems has resulted in the manufacture of a wide variety of hardware and software information handling system configurations. One difficulty with operation of a wide variety of hardware and software configurations is that a failure of an information handling system is often difficult to diagnose and correct. Typically, information handling system manufacturers have service centers that aid information handling system users with failures. Generally, the user calls a toll free number of a service center and describes the difficulty to a service technician who attempts to diagnose and correct the problem by describing corrective actions for the user to perform. However, user calls to a service center are expensive for the manufacturer and often an inefficient use of technician time. For instance, resolution of hardware versus software difficulties typically rely on different types of expertise. Thus, isolating and correcting a difficulty may result in the user having to talk with different technicians and, ultimately, end up with replacement hardware components being shipped to the user.

In order to aid in resolution of information handling system difficulties, diagnostics modules are sometimes installed on information handling systems during manufacture. For example, industry standard diagnostic routines have been developed to provide customer-based hard disk drive (“HDD”) self-test routines. Typically, these diagnostic routines provide data driven analysis of the hard disk drive, such as by writing data to the drive and then reading the data to compare the results to the written data. These diagnostic routines are typically invoked by diagnostic software applications that reside on the host computer. Industry standard diagnostic routines typically consist of a short and long test cycle. The long test cycle provides a diagnosis with over 95% accuracy and relies completely on HDD data reads and writes. If a user has difficulty with the information handling system, the user runs the diagnostics module to attempt to isolate the problem, thus reducing the time needed by the user to talk with a technician. Further, a hardware component failure diagnosed by a diagnostics module is more likely to be correct than a technician analysis accomplished by a phone conversation. Thus, use of a diagnostics module reduces the risk that a replacement component will be shipped when the original equipment is not faulty. Indeed, the PC industry and its suppliers have noted that a large percentage of hard disk drives returned are designated as no problem found. In some instances, seventy percent of hardware components replaced by technician diagnosis cannot duplicate the reported failure on return to the manufacturer. This happens because end users and technicians experiencing system problems can interpret a number of system issues as hard drive failure. HDD failure or replacement is disruptive to the end-user and results in excessive supplier warranty cost.

Although the use of the diagnostic module improves the accuracy of hardware component failure diagnosis, users and technicians often fail to run the diagnostics modules, instead relying on operational indications to deduce failed hardware components. Alternatively, diagnostics may be too late to prevent data loss, or may not provide a warning of potential device failure. Information handling system manufacturers have little opportunity to determine if the diagnostics module was run or to determine the accuracy of the diagnostics module at detecting component failures except to test returned components for duplication of reported failures.

In addition to data driven diagnostic techniques, there are other diagnostic tools used for analyzing acoustic or vibratory signals generated by electromechanical devices. However, such techniques are primarily confined to the research and development settings where external noise that can distort the signal detection is eliminated or reduced in a controlled environment. Heretofore, such diagnostic tools have not been implemented for providing accurate diagnostic analysis of component devices in an information handling system, nor have such diagnostic tools been available for use in commercial manufacturing or consumer settings where external noise has not been carefully controlled.

Further limitations and disadvantages of conventional systems will become apparent to one of skill in the art after reviewing the remainder of the present application with reference to the drawings and detailed description which follow.

### SUMMARY OF THE INVENTION

In accordance with the present invention, a method and system are provided which substantially reduce the disadvantages and problems associated with previous methods and systems for diagnosis of information handling system hardware component failures. In accordance with the present invention, a method and system are provided to improve the detection and diagnosis of a computer or peripheral device performance by providing a physical sensor proximate to the device for sensing a physical property indicating actual or potential failure of the device. In one embodiment, a microphone is included in a hard disk drive device to use drive acoustic spectral information to detect potential drive failure and/or validate drive functionality. The data provided by the microphone is used in conjunction with diagnostic routines for analyzing detected noise or pressure signals generated by the drive. For example, detected sound signals are used to generate an acoustic frequency response of the HDD under test and compare that response with acoustic models developed from known good drives. The acoustic pass/fail criteria are used in one embodiment for customer self-test as well as manufacturing line product test. An integrated microphone enables real-time analysis of drive acoustic power spectra to identify changes over time which may indicate drive failure. Specific acoustic models detect changes/defects in spindle motor profile, head flyability, load/unload, and seek profiles. In a selected embodiment, the microphone would be a silicon microphone which is compatible with standard surface mount soldering processes, has high shock resistance, and has low vibration sensitivity.

In accordance with the invention, a system for detecting a hardware component failure is provided which includes a sensor for detecting a physical property of the hardware component, such as sound information created by the component during operation. The system also includes a diagnostics module for analyzing the detected signal based upon the physical property. When the physical property is sound pressure or energy, a microphone, such as a silicon microphone, may be used as the sensor. Such a sensor may be used to detect sound information generated by a hard disk drive when the microphone is affixed near or integrated within the hard disk drive. In operation, the diagnostics module creates a sound spectra profile based upon the detected physical property and compares the profile to a benchmark measure to determine whether to issue a failure signal. The benchmark measure may be the profile for a valid and operative hardware component, or may represent a specific defective operative condition for the component. The failure signal generated as a result of the diagnostics analysis indicates that the device has failed or that the device is about to fail. This determination is based upon a single measurement and analysis of the hardware component, or alternatively, is based upon multiple measurement profiles that provide an indication of the component performance over time.

With an alternative embodiment of the present invention, a method for diagnosing hardware component failure is provided which is initiated by use of a diagnostics program which is locally stored or alternatively stored in a centralized location. Upon initiation, the specific hardware component being diagnosed is activated in a controlled fashion, so as to specify a particular function of operation and/or to remove any background noise. Audio signals generated by the hardware component are detected and converted into a first audio profile which is compared to a predetermined profile to determine if the hardware component has failed or is about to fail. In a selected embodiment, the audio profile is an acoustic power spectra representing the detected audio signals. When the hardware component being diagnosed is a hard disk drive, any of a variety of audio profiles may be used in the diagnosis, including but not limited to an acoustic model representing a defective spindle motor profile, head flyability profile, load/unload profile, or seek profile for the hard disk drive.

In accordance with a still further embodiment of the present invention, an apparatus is provided for detecting drive failure. The apparatus includes a drive, such as, for example, a hard disk drive, CD-ROM drive or DVD drive. A sensor is positioned to detect electromagnetic or sound wave signals generated by the operation of the drive. An example of such a sensor includes a silicon microphone affixed proximate to or within the drive structure. The information handling system is coupled to the sensor to convert the detected electromagnetic signals into a first profile. This is compared to a reference profile to detect drive failure, and a drive failure signal is issued. Multiple profiles are collected over time for the drive, and these profiles are analyzed by the information handling system to provide an early indication of drive failure.

The present invention provides a number of important technical advantages. One example of an important technical advantage is that it reduces service technician talk time for analysis of information handling system hardware component failures. For instance, if spectral analysis of the hardware device verifies failure of the device, automated ordering and shipment of a replacement component is provided without using a service technician. For those instances where the device failure is not detected, the diagnostics engine directs the handling of the reported failure to reflect this fact. In this manner, service technician time is used more efficiently to reduce the expense associated with service of an information handling system failure.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a hardware component failure detection and diagnosis system.

FIG. 2 shows details of a hardware component failure detection and diagnosis system that analyzes the acoustic power spectra of a hard disk drive component.

FIG. 3 depicts a flow diagram of a process for detecting and diagnosing device performance using measurements of the device's physical properties.

FIG. 4 depicts a flow diagram of a process for detecting HDD failure by comparing profile information for the HDD.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence or data for business, scientific, control or other purposes. For example, an information handling system may be a personal computer, a network storage device or any other suitable device and may vary in size, shape, performance, functionality and price. The information handling system may include random access memory (RAM), one or more processing resources such as a central processing unit (CPU) or hardware or software control logic, ROM and/or other types of nonvolatile memory. Additional components of the information handling system may include one or more disk drives, one or more network ports for communicating with external devices as well as various input and output (I/O) devices, such as a keyboard, a mouse and a video display. The information handling system may also include one or more buses operable to transmit communications between the various hardware components.

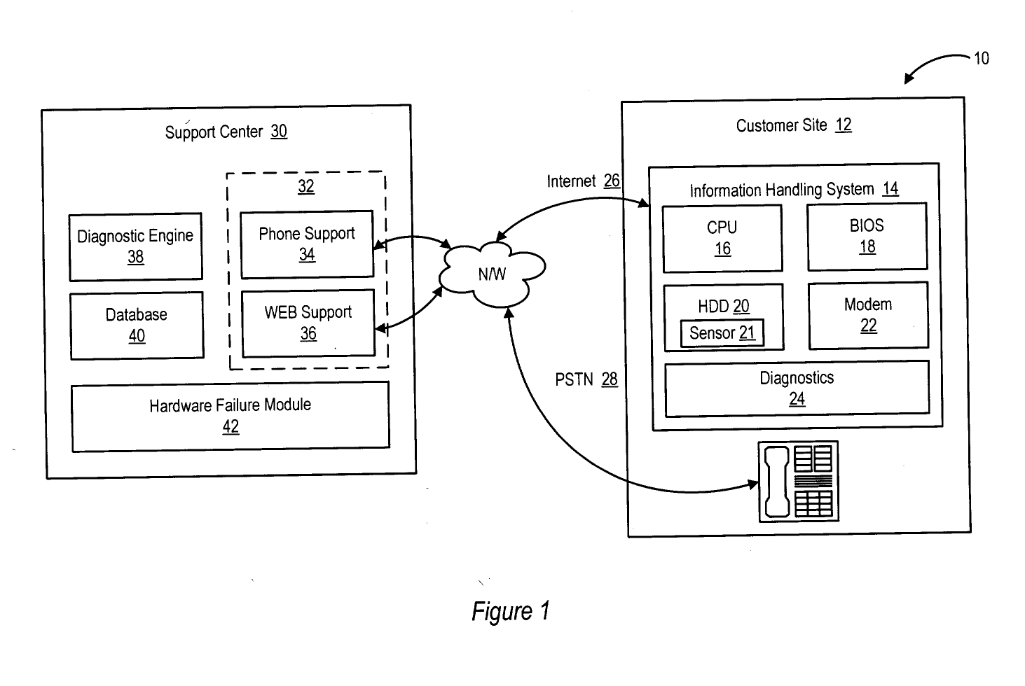

Referring now to FIG. 1, a block diagram depicts an information handling system hardware component failure detection and diagnosis system 10. A customer site 12 has one or more information handling systems 14, each information handling system operating with a variety of hardware components, such as a CPU 16, BIOS 18, hard disk drive 20 and modem 22 or other network physical interface. Located proximate to a hardware component, such as HDD 20, is a sensor 21 for detecting or sensing a physical property of the component indicating the component's performance level. In a selected embodiment, the sensor 21 is a microphone for collecting or measuring acoustic signals generated by the HDD 20. Other implementations include using an accelerometer to measure vibration, a heat sensor to measure temperature, a particle detector to measure impurities or contaminants or a sensor to measure humidity, and such other instrumentalities for measuring physical properties.

By affixing or positioning the sensor 21 within the HDD chamber or casing, the sensor obtains accurate readings because of the proximity to the property being measured. In addition, the positioning of sensor 21 within the casing for HDD 20 effectively reduces or minimizes amount of external noise that is detected in relation to the physical property being measured within the HDD 20. As a result, the present invention provides improved signal-to-noise ratio. Additional benefits are provided by providing a relatively small acoustic chamber for a sound sensor embodiment of the present invention. As will also be appreciated, proximate placement of the sensor 21 to the device being tested reduces or eliminates the path component of any detected noise waveform.

The information detected by sensor 21 may be provided to a diagnostics module 24 that is loaded on information handling system 14 to run diagnostics on the hardware components for detecting and identifying hardware component failures. The present invention may be used in conjunction with any of a variety of industry standard diagnostic routines or other software diagnostic tools for analyzing the performance of electrical and mechanical device performance. As those skilled in the art will appreciate, the vibratory or acoustical signals picked up by a sensor and used for diagnostics can be processed in many ways. For example, there are a variety of techniques that use the overall mean or integral square or a power spectrum to characterize the sound generated by devices. For rotating machines (such as hard drives), energy versus time analysis of the machine vibration, when used in connection with the present invention, may be used to provide a reliable and accurate acoustical measurement of the sound output of the HDD as part of the quality control procedures used by the HDD manufacturer. The present invention may also be used with diagnostics tools that use the power cepstrum of the device noise. For example, diagnostics are performed on the recovered source spectrum. Also, the system impulse response that is determined from the detected sound signals can be expanded in a sequence of orthonormal functions, which are used to represent the device performance for diagnostics purposes. These and other diagnostic analyses and approaches, which can be used in connection with the present invention, are described in R. Lyon, Machinery Noise and Diagnostics, chapters 6-8 (Butterworth 1987), which is hereby incorporated by reference in its entirety.

The present invention has many different beneficial applications. For example, an HDD device manufacturer can incorporate the present invention during assembly of the HDD devices, and then perform quality control testing at the manufacturing factory. With the improved noise shielding and signal detection, the present invention can be used in a noisy factory environment. In addition, by providing for component device testing, defective devices can be detected and removed prior to assembly of the device in a completed product, such as an information handling system.

The integrated detection functionality of the present invention can also be applied after the HDD device has been assembled into a completed information handling system. For example, if an information handling system user at customer site 12 has difficulty operating information handling system 14, the user runs diagnostics module 24 to determine if the difficulty is related to a hardware component failure. If so, the user contacts a support center 30 through a communication interface, such as Internet 26 or the Public Switched Telephone Network 28, to report the hardware component failure and order a replacement for the failed hardware component.

Inquiries from an information handling system user to support center 30 are handled through a support center user interface 32 having telephone or Web browser interfaces. Telephone inquiries from customer site 12 through PSTN 28 are answered with automated phone support module 34, such as with an interactive voice response unit (IVRU). Web browser inquiries from customer site 12 through Internet 26 are answered with an automated Web support module 26 that presents a graphical user interface to the user. Each phone support module 34 and Web support module 36 requests that the user input a diagnostics information provided by information handling system 14. Diagnostics module 24 generates the diagnostics information for any detected failures of a hardware component.

A diagnostics engine 38 of support center 30 accepts the diagnostics information from user interface 32. After confirming that the user qualifies for technical support (by comparing user information to account information stored in database 40), diagnostics engine 38 confirms that the failed hardware component and failure types match values generated by a diagnostics module 24. For instance, the information handling system shipped hardware and software configuration is retrieved from database 40 and compared with information provided by the diagnostics module 24, such as the diagnostics date and time, diagnostics results, hardware on which diagnostics was run, the number of diagnostics runs, operating system and version used on the information handling system, driver versions and other desired information. If analysis of the diagnostics information by diagnostics engine 38 confirms a failed hardware component, technical support may be redirected based on this information. For example, a hardware failure module 42 may initiate shipment of a replacement part by a hardware shipper to customer site 12. In this manner, the customer has failed hardware components replaced without having to talk with a service technician. Alternatively, support center handling of the customer call may be based on stored information in the database 40 reflecting the results of the customer site diagnostics, such as device failure, device failure warning or invalid device.

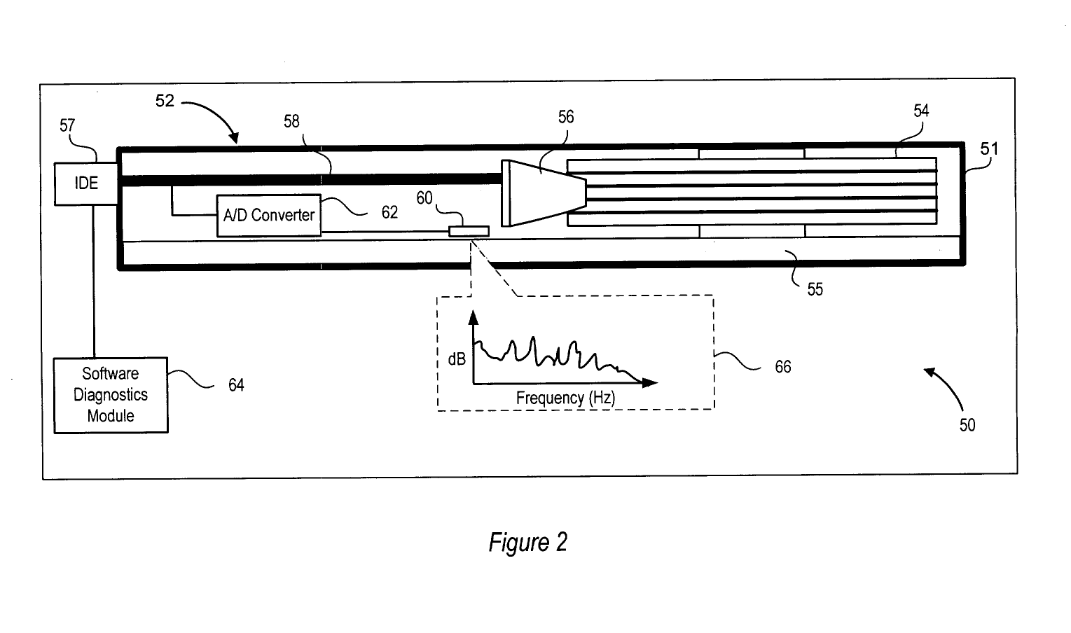

Referring now to FIG. 2, a diagram is provided for an embodiment of the hardware component failure detection and diagnosis system 50 that analyzes the acoustic power spectra of a hard disk drive component 52. The hard disk drive 52 shown in FIG. 2 includes an external casing or housing 51 enclosing platters 54 for storing data, arm 56 for reading and writing data to and from the platters 54 and flexible cable 58 for coupling the data to and from the hard disk drive 52. In addition, a microphone 60 is positioned proximately to the hard disk drive component 52 for collecting or sampling sound signals generated by the hard disk drive 52. For example, microphone 60 measures the sound pressure over a certain time interval. The detected sound information is converted by analog-to-digital converter 62 into digital form (representing the microphone voltage) as a function of time. As depicted, the sensor 60 and analog-to-digital converter 62 are mounted on a printed circuit board assembly 55 within the hard drive 52, though the sensor could be affixed in other ways within the hard drive 52 consistent with the present invention.

In a selected embodiment, the digitized data is coupled through the IDE interface 57 to the exterior of the hard drive 52 so that existing pin outputs are used for data communication. For example, sensor data could be time multiplexed with other data over the IDE cables. A variety of alternative coupling techniques could also be used, including use of conductors within in printed circuit board assembly 55, separate shielded conductors or a wireless transmitter with an associated receiver outside the hard drive 52.

However conveyed, a diagnostics module 64 receives digital data representative of the detected sound or pressure signals and performs an analysis of these numbers. In a selected embodiment, the diagnostics module 64 resides within the software or hardware of the computer that is attached to the hard drive 52. In this way, the local CPU and associated memory provide data analysis tools for performing diagnostics on the hard drive 52. As an example of such diagnostics analysis, a sound spectra profile 66 is generated, based upon the physical property measurements collected by microphone 60 from the hard disk drive 52.

In a selected embodiment, the microphone 60 is a silicon-based condenser microphone consisting of a thin diaphragm and a back plate. The diaphragm vibrates when sound energy or pressure impinges on it. Vibration of the diaphragm changes the condenser capacitance. The condenser capacitance is then converted to a voltage that corresponds to the sound signal. By placing the condenser microphone within the drive housing, a clean acoustic spectrum is detected with any external noise being minimized in relation to the drive noises being measured, both because of proximity within a small enclosure and the shielding provided by the drive casing 51.

While the present invention may be implemented with conventional discrete microphones, silicon microphones have certain advantages in cost and performance over discrete microphones. For example, discrete microphones consist of many small parts which can cause performance problems in the final product, including uneven characteristics and insufficient durability. By the nature of their manufacture, silicon microphones have consistent performance, are structurally robust, have a wide dynamic range, have excellent sensitivity and frequency characteristics, are durable, can be used in high-temperature and high humidity environments and can be readily customized because of their configurable shapes and characteristics.

The present invention may also be implemented to detect performance degradation in other information handling system components and devices. For example, information handling systems include power devices that create tonal noise when they begin to deteriorate, such as LCD inverters used in connection with computer displays using LCD backlighting. By positioning and/or integrating a microphone, such as a silicon microphone, adjacent or within the display device, the performance of the LCD inverters in the display can be monitored using a diagnostics module stored on the information handling system. By comparing the detected tonal waveform to a benchmark waveform for an operative and functional LCD inverter, the present invention can determine when the LCD inverter(s) begins to deteriorate below a threshold level of performance.

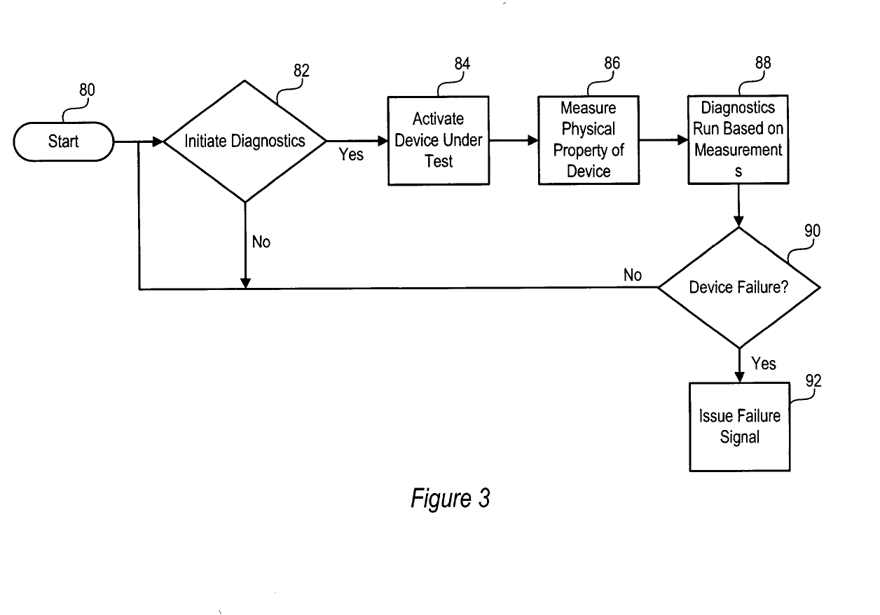

Referring to FIG. 3, a flow diagram depicts the process for detecting a device performance condition by using the measurement of a physical property of the device. After beginning the process at step 80, diagnostics testing procedures for detecting device performance are initiated at step 82. As described generally with reference to the process shown in FIG. 2, the specific physical property being detected can include any electromagnetic activity generated in connection with the operation of the device. For example, sound waves generated by the device can be detected with a microphone. Alternatively, other parameters may be detected, such as pressure, temperature or any of a variety of reflected or transmitted light waves, including infrared or ultraviolet light as well as reflected visible light.

As will be appreciated, diagnostics can be initiated when the user runs a diagnostics module on an information handling system. Alternatively, device detection can be initiated on a predetermined basis, such as upon start-up or power-up of the information handling system, or at predetermined or periodic intervals so that the device performance can be measured to detect changes over time.

After initiation of the detection function, the specific device being measured is activated in a controlled fashion at step 84. It will be appreciated that the device activation step 84 may precede or follow the detection initiation step 82, depending upon which aspect of the device is being measured. In a selected embodiment, background noise can be further minimized or controlled during device activation step 84 by controlling the operation of other hardware components within the information handling system so that other devices are not active at the same time as the device being tested. In addition, the device being tested at step 84 may be controlled to activate certain specific activities. For example, if hard disk drive component is being tested, it can be activated to write data to the HDD, to read data from the HDD, to spin the HDD platters, to seek, etc.

As described herein, each specific function being activated can be detected and compared to a benchmark measure to determine whether the device is operative or to predict device failure. At step 86, the specific physical property of the device being detected is measured. For example, a microphone can be placed adjacent the device being tested to measure sound waves generated by the device when activated. The microphone converts sound pressure or energy into an electrical signal. This electrical signal may be converted into digital form, preferably with an analog-to-digital converter that is located with the sensor inside the device housing. In a selected embodiment, the physical property measured at step 86 includes sound measurements at a plurality of frequencies that collectively provide a sound spectra profile for the activated device being measured. In accordance with the present invention, the measurement step 86 can occur once (such as upon activation of a diagnostics program by the user), or can occur repeatedly or periodically over time. In this way, changes over time in the sound spectra profile can be used to identify potential device failures.

Although a variety of sound detection devices can be used in accordance with the step 86, a silicon microphone provide numerous advantages over convention microphones, such as compatibility with surface mount soldering process technology, high shock resistance, low vibration sensitivity and the ability to be included in the original manufacture of the hard disk drive component or in the assembly of an information handling system containing such a component.

At step 88, the detected measurements of the activated device are used to analyze the performance of the device. For example, a diagnostics module contained within the information handling system where the device is located can compare the detected measurements with reference information developed from known operative devices. In a selected embodiment where the performance of a hard disk drive component is being analyzed, the data provided by microphone 60 can be used in conjunction with diagnostic routines to compare the acoustic frequency response of the hard disk drive 52 under test with acoustic models developed from known good drives. If the measured acoustic frequency response matches a valid acoustic model, then it is determined that there has not been a device failure (step 90), and the testing process terminates or is returned to the start step 80. Alternatively, if it is determined at step 90 that the device under test has failed, a failure signal is issued at step 92.

Sophisticated analysis and diagnostics tools known to those skilled in the art can be used at diagnostics step 88 to evaluate the signal data collected by the present invention. For example, a series of sound spectra profiles generated over time can be compared to a known benchmark profile and used to provide early detection of device failure at step 90. In addition to using benchmark profiles representing valid device performance, the analysis step 88 may also use acoustic models developed for defective device performance. For example, specific acoustic models can be developed to detect changes or defects in the spindle motor profile, head flyability profile, load/unload profile and seek profile. The diagnostic step 88 can compare the measured sound spectra profile to a profile for a defective device to determine whether there has been or is going to be a device failure at step 90.

In addition, part of the diagnostics analysis can include filtering or removal of extraneous noise. For example, to measure the amount of background noise when the device is inactive, sensor 21 may detect the background noise when the device is inactive, providing a profile that can be subtracted from the measured profile for an active device.

Upon determination of devices failures at step 90, the diagnostics module may issue a failure signal at step 92. The failure signal can be used to signify actual or predicted device failure, and to prompt the user to undertake protective measures, or to assist with technical support for the information handling system.

It will be appreciated that the analysis at step 88 may be implemented with a diagnostics module 24 that is resident on the same information handling system as the device being tested. Alternatively, the diagnostics may be performed remotely, such as under control of a hardware failure module 42 located at support center 30. The distributed nature of the diagnostics and analysis reduces the memory load for the customer's information handling system. In addition, centralized control of the diagnostics functionality allows the support center to provide controlled diagnostics which can reflect improvements in the diagnostics capability developed over time.

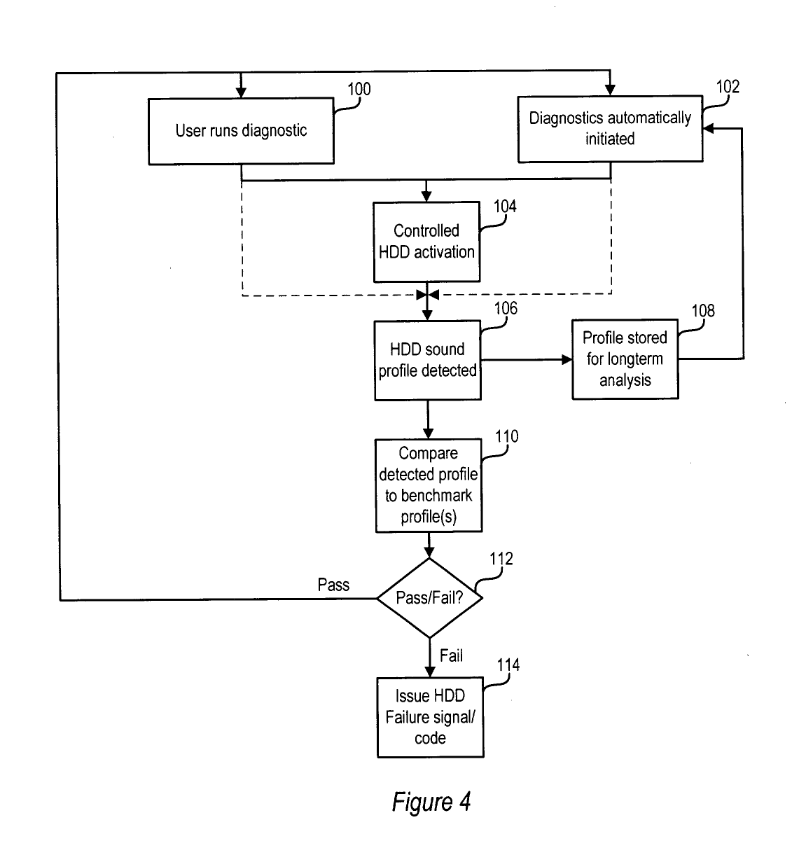

Referring to FIG. 4, a flow diagram depicts the process for detecting the acoustic or sound waves generated by a hard disk drive and processing the detected information to provide a representation of the hard disk drive performance (such as a power spectra analysis) for use in performing diagnostics on the hard drive. At step 100, the user runs a diagnostics program, such as stored at the diagnostics module 24 in the information handling system 10. Alternatively, the process can be automatically initiated at step 102, such as through a pre-programmed interval or upon a predetermined event, such as start-up of the information handling system.

At step 104, the hard disk drive being tested is activated under a controlled sequence. The controlled activation can be used to eliminate background noise generated by other hardware components in the information handling system. In addition or in the alternative, specific functions of the hard disk drive (e.g., read, write, seek) can be activated for purposes of performance measurement. As indicated by the dashed lines in FIG. 4, no particular controlled activation sequence is required, and step 104 may be bypassed when an uncontrolled HDD sound profile is detected.

Upon activation of the hard disk drive, a sound profile for the hard disk drive is detected at step 106. At this step, sound can be detected with a microphone that is located adjacent to the hard disk drive or integrated within the hard disk drive. For example, a silicon microphone manufactured as part of the interior space of the hard disk drive or attached as part of the information handling system assembly can detect sound waves generated by the hard disk drive during its operation. The sound waves are converted to profile information at step 106, such as acoustic power spectra profiles, and can be stored at step 108 for use in analyzing the performance of the bard disk drive over time. Alternatively, a single profile can be used to analyze the hard disk drive performance. As will be understood by those skilled in the art, a sound spectrum is a representation of a sound in terms of the amount of vibration at each individual frequency. Sound spectra are usually presented as a graph of either power or pressure (measured in decibels) as a function of frequency (measured in vibrations per second.

As indicated at step 110, computer-based analyses of the detected sound profile can be performed, including comparison of the detected sound profile to a benchmark profile. For example, a benchmark profile may represent the performance of an operative hard disk drive. Alternatively, multiple benchmark profiles can be developed based on models of specific hard disk drive performance conditions, including valid or defective disk drive performance conditions. As another example, selected frequency components can be combined or otherwise mathematically manipulated to obtain a composite value which can be compared to reference composite value(s) representing a threshold for acceptable performance. Persons skilled in the art will appreciated additional diagnostic techniques that can be applied to the detected sound profile to provide early detection of drive failure and/or otherwise assess the performance of the HDD.

As a result of the comparison step 110, a determination is made at step 112 on whether the hard disk drive is defective. In addition or in the alternative, the determination at step 112 can include predicting device failure based upon the results of comparison step 110. If it is determined at step 112 that the hard disk drive is operative, the process restarts, either by waiting for the user to run the diagnostic program at step 100, or automatically restarts at step 102.

If the hard disk drive is determined at step 112 to be defective, a hard disk drive failure signal or code is issued at step 114. The failure signal or code can be used to assist with further diagnostics. In addition, the failure signal or code can be used by technical support or customer support to correct or replace the defective hard disk drive.

The above-discussed embodiments include software that performs certain tasks. The software discussed herein may include script, batch, or other executable files. The software may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the software may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple software modules into a single module or may impose an alternate decomposition of functionality of modules. For example, a software module for calling sub-modules may be decomposed so that each sub-module performs its function and passes control directly to another sub-module.

While the system and method of the present invention has been described in connection with the preferred embodiment, it is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. An information handling system for detecting failure of a hardware component in the information handling system, comprising:
a processor;
memory interfaced with the processor;
program code stored by the memory and executable by the processor;
a hardware component;
a sensor positioned within the hardware component for detecting an acoustic property of a hardware component in an information handling system;
where the program code comprises a diagnostics module for analyzing the detected acoustic property and issuing a hardware component failure signal based upon the detected acoustic property.

2. The system of claim 1 wherein the sensor comprises a microphone and the acoustic property comprises sound pressure generated by the hardware component.

3. The system of claim 1 wherein the sensor comprises a silicon microphone and the hardware component comprises a hard disk drive.

4. The system of claim 3 wherein the silicon microphone is integrated with the hard disk drive.

5. The system of claim 1 wherein the diagnostics module generates a first sound spectra profile based upon the detected acoustic property and compares the first sound spectra profile to a benchmark spectra profile in determining whether to issue a hardware component failure signal.

6. The system of claim 5 wherein the benchmark spectra profile represents an operative hardware component.

7. The system of claim 5 wherein the benchmark spectra profile represents at least a first inoperative condition for the hardware component.

8. The system of claim 1 wherein the hardware component failure signal comprises a warning that hardware component failure may be imminent.

9. The system of claim 1 wherein the diagnostics module generates, at predetermined intervals, a plurality of sound spectra profiles based upon the detected acoustic property and analyzes changes in the plurality of sound spectra profiles over time in determining whether to issue a hardware component failure signal.

10. A method for diagnosing hardware component failure, the method comprising:
initiating diagnostics on an information handling system to determine a hardware component failure;
activating the hardware component using a control sequence;
detecting audio signals generated by the activated hardware component to generate a first audio profile;
comparing the first audio profile to at least a first predetermined audio profile to determine if there is a hardware component failure.

11. The method of claim 10 further comprising providing an indication that the hardware component has failed.

12. The method of claim 10 further comprising providing an early indication of hardware component failure.

13. The method of claim 10 wherein the first audio profile comprises acoustic spectral data representing the detected audio signals.

14. The method of claim 10 wherein hardware component comprises a hard disk drive, and the first predetermined audio profile comprises an acoustic model representing a defective spindle motor profile, head flyability, load/unload or seek profile.

15. The method of claim 10 wherein the detecting step comprises sensing audio signals with a microphone.

16. The method of claim 15 wherein the microphone comprises a silicon microphone affixed proximate to the hardware component.

17. An apparatus for providing detection of drive failure, comprising:
a drive;
a sensor positioned to detect electromagnetic signals generated by operation of the drive;
a controller coupled to the sensor for creating a first profile based upon the detected electromagnetic signals, comparing the first profile to a reference profile to detect drive failure based on the comparison and generating a drive failure signal.

18. The apparatus of claim 17 wherein the drive comprises a hard disk drive component of an information handling system, the detected electromagnetic signals comprise sound signals generated by the drive, the sensor comprises a silicon microphone and the controller comprises a diagnostics routine stored on the information handling system.

19. The apparatus of claim 17 wherein the drive failure signal comprises an early indication of drive failure, wherein the reference profile comprises an acoustic model of an operative drive, and wherein the controller further comprises a diagnostic routine for providing the early indication of drive failure based upon a comparison of the first profile to the acoustic model of an operative drive.

20. The apparatus of claim 17 wherein the controller creates additional profiles based upon additional sensor samples over time and generates a drive failure signal based upon changes in the multiple sensor samples over time.
